(19) United States
(12) Patent Application Publication
(10) Pub. No.: US 2026/0227987 A1
(43) Pub. Date: Aug. 6, 2026

(54) SOFTWARE UPDATE HEALTH REGRESSION DETECTION

(71) Applicant: Microsoft Technology Licensing, LLC, Redmond, WA (US)

(72) Inventors: Akshay Sudhir Bapat, Bothell, WA (US); Harish Srinivasan, Sammamish, WA (US); Amitabh NAG, Redmond, WA (US); Kristofer A. Riedman, Everett, WA (US); Lin Zheng, Gold River, CA (US); Josh Charles Moore, Lynnwood, WA (US); Sandeep Repaka, Sammamish, WA (US)

(73) Assignee: Microsoft Technology Licensing, LLC, Redmond, WA (US)

(21) Appl. No.: 19/042,904

(22) Filed: Jan. 31, 2025

(51) Int. Cl. G06F 8/65; G06F 11/34

(52) U.S. Cl. CPC G06F 8/65; G06F 11/3447; G06F 11/3452

(57) ABSTRACT

Systems and methods for automatically reducing regression for a software update applied to a population of nodes in a computing environment. A regression detector performs a health analysis of the software update and detects a software regression attributed to the software update with high confidence by performing a combination of data analyses. In some examples, a time window-based observational study, a control-based observational study, and an anomaly detection analysis are performed for identifying various regression conditions. When the identified regression conditions match a set of high-confidence regression conditions configured for the health analysis, a software regression is detected. In further examples, the regression detector transmits an event based on the detected software regression to prevent the software regression from propagating to additional nodes in the computing environment.

### BACKGROUND

Cloud computing systems and other shared computing environments include multiple computing nodes that provide software applications and services to users via the Internet and/or other networks. For instance, software code for applications that provide content creation, communication, data storage, data manipulation, and/or other services, as well as the operating systems, are regularly updated to add features, correct errors, respond to user requests, and the like. In some cases, software payloads that may include many thousands of code changes across some or all of the applications or operating systems are rolled out to the computing nodes. Application of the software payloads to software systems sometimes results in software regression (e.g., where an update causes a previously working feature to fail) and/or software performance regression (e.g., where the system's performance degrades after the update).

It is with respect to these and other considerations that examples have been made. In addition, although relatively specific problems have been discussed, it should be understood that the examples should not be limited to solving the specific problems identified in the background.

### SUMMARY

The technology described herein describes systems and methods to provide automated regression detection for reducing regression for a software update applied to a population of nodes in a computing environment. A regression detector performs a health analysis of the software update and detects a software regression attributed to the software update with high confidence by performing a combination of data analyses. In some examples, a time window-based observational study, a control-based observational study, and an anomaly detection analysis are performed for identifying various regression conditions. When the identified regression conditions match a set of high-confidence regression conditions configured for the health analysis, a software regression is detected. In further examples, the regression detector transmits an event based on the detected software regression to prevent the software regression from propagating to additional nodes in the computing environment.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example by the accompanying figures, in which like references indicate similar elements. Elements in the figures are illustrated for simplicity and clarity and have not necessarily been drawn to scale.

FIG. 1 is a block diagram of a system in which a regression detector is implemented for providing automated regression detection according to an example;

FIG. 2 depicts example components of the regression detector;

FIG. 3 depicts a first example observational study performed by the regression detector according to an example;

FIG. 4 depicts a second example observational study performed by the regression detector according to an example;

FIG. 5 depicts an example anomaly detection analysis performed by the regression detector according to an example;

FIG. 6 depicts example output of the regression detector;

FIG. 7 depicts a flow chart of a method for detecting a regression according to an example; and

FIG. 8 is a block diagram illustrating example physical components of a computing device with which examples of the disclosure may be practiced.

### DETAILED DESCRIPTION

Implementations of the present disclosure use a regression detector to provide regression detection and management in a computing system according to examples. As noted, software updates may result in health regressions that reduce computing system performance for affected users. Accordingly, aspects described herein perform a combination of data analyses (e.g., observational studies and anomaly detection) to evaluate health data in an observation window around deployment of the software update to identify health regressions attributed to the update. In examples, further software regression caused by software update rollouts may be prevented by automatically detecting potential regressions between early phases of deployments of the software update and preventing the software regression from propagating to all nodes in a computing environment. The quality of regression detection and steps taken to address a regression issue are limited by the degree of accuracy with which the target update failure is labelled as a regression failure, as opposed to failures that just happen to be coincident with a software update rollout being labelled as regression failures, therefore it is important to disambiguate these events which may be easily misconstrued as the other. Previous observational study methods used in regression detection oftentimes produce false positives by mislabeling coincidental failures as regression failures, thus undermining trust and reliability of the regression detection system. Additionally, previous anomaly detection methods may fail to account for background noise, leading to spurious anomalies. A regression detector described herein performs a health analysis of the software update and detects a software regression attributed to the software update with high confidence by performing a combination of a time window-based observational study, a control-based observational study, and an anomaly detection analysis. Implementation of aspects presented herein allows for software regressions to be detected with a high degree of accuracy and precision and mitigated early in a software update rollout, resulting in better performance. Some embodiments described herein therefore result in more efficient use of computing system resources, and improved operation of computing systems for users.

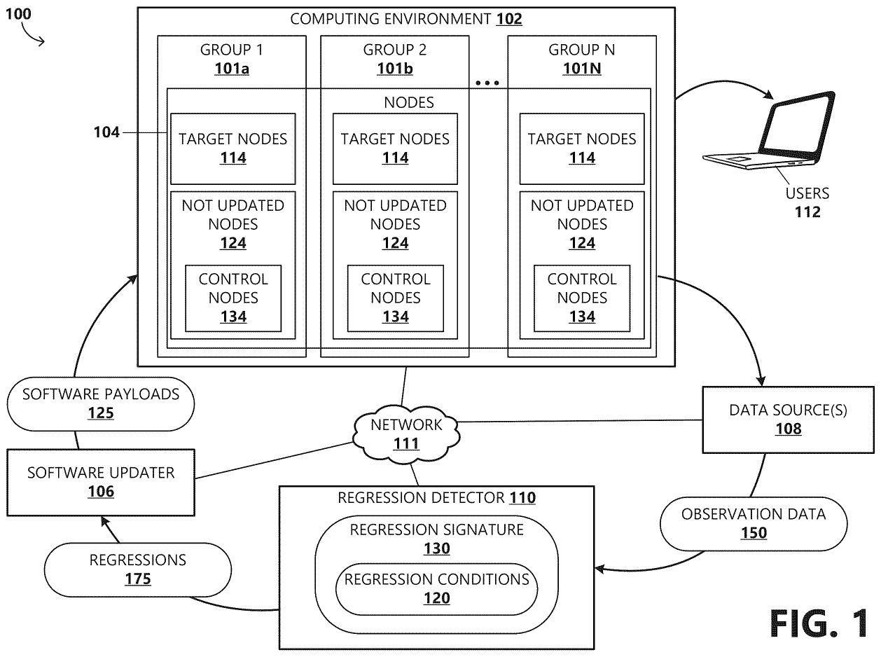

FIG. 1 illustrates an example system 100 in which a regression detector 110 is implemented for providing automated health regression detection. Components of the system 100 communicate via one or a combination of networks 111, such as a wide area network (e.g., the Internet), a local area network (e.g., an Ethernet or Wi-Fi network), a cellular data network, and combinations or derivatives thereof. Although the example system 100 is depicted as including a particular combination of computing environments, devices, networks, etc., the scale and structure of the system 100 may vary and may include additional or fewer components and in different arrangements than those described in FIG. 1.

The regression detector 110 operates to automatically identify and respond to software regressions 175 attributed to a phased rollout/deployment of a software update to nodes 104 of a networked computing environment 102. As used herein, the term “regression” generally refers to a condition where a previously functioning feature or functionality of a software application (a workload) or the node 104 on which the workload is executed experiences a failure after the software update is made to the software application. In the context of identifying a regression 175, a “failure” can include an event where the workload or node 104 does not perform as intended or expected (e.g., a crash or failure of a particular software feature to operate, increased latency of a particular software feature, or decreased reliability of a particular software feature). According to examples, software features include features of operating systems, applications, or other types of software operating on the nodes 104, the failure of which degrades user experience, node 104 performance, computing environment 102 performance, etc.

Nodes 104 are computing instances or devices within the computing environment 102 that include electronic processors executing software code for hosting an operating system and providing applications and/or services to users 112. For instance, nodes 104 may include virtual machines (VMs) in a cloud computing environment, physical desktop or laptop computers, on-premises servers, mobile devices, Internet of Things (IoT) devices, embedded computing systems within vehicles, or other types of computing devices that run workloads by executing software code. In some implementations, such as in a cloud computing environment, users 112 are provided with applications and other computing services remotely, via one or more nodes 104 representing a dedicated software environment (e.g., a VM), which is secured from other nodes 104 and accessible by an authorized group of users. In examples, nodes 104 in the computing environment 102 are organized into one or more groups 101 (group 1 101a through group N 101N, where N represents a number of groups). Organization of nodes 104 into groups 101 may be based on logical, geographical, or operational criteria (e.g., physical location, data center, network segment, functional role, etc.). In some implementations, a group 101 may include hundreds, thousands, tens of thousands, or more nodes 104.

According to an aspect, a node 104 serves as a distinct endpoint in a deployment process of an update to software code executed by the node 104. The software code may be updated to add features, correct errors, make improvements, respond to user requests, and the like. In some examples, the deployment process is executed by a software updater 106. For instance, the software updater 106 rolls out/deploys software payloads 125 (including one or more software updates) to a target population of nodes 104 (referred to herein as target nodes 114). Software payloads 125 include files, scripts, and/or other data created as part of the software update that is distributed to and installed on target nodes 114. In some examples, software payloads 125 include many (e.g., one thousand or more) changes to the software code executed by the computing environment 102. In examples, a software update is deployed to different populations of target nodes 114 of a group 101 in a plurality of phases. For instance, at a given point in time, a group 101 in the computing environment 102 can include a population of target nodes 114 that have been updated and another population of not updated nodes 124 that have not yet received the software update and/or completed deployment of the software update. One or more not updated nodes 124 may be a target for an upcoming deployment of the software update in a subsequent phase.

According to an aspect, the regression detector 110 operates to perform a health analysis corresponding to a software update. In some examples, the health analysis is performed after at least a first population of target nodes 114 in a group 101 has received the software update. For instance, the regression detector 110 is configured to identify failure signatures in collected observation data 150 indicative of a software regression 175. According to an aspect, the regression detector 110 uses a combination of data analyses (e.g., various observational studies and anomaly detection) to evaluate observation data 150 and determine whether a regression signature 130 (including a combination of regression conditions 120) used to identify a regression 175 with high confidence is satisfied.

As further used herein, the term observation data 150 generally refers to telemetry data, electronic messages, or other type of data received from automated communications processes by which measurements, operating status, execution results, and/or other health related data are collected and transmitted to a receiving computing device (e.g., a data source 108 or the regression detector 110). For instance, observation data 150 may include data points representing requests received by applications, dependencies (calls to external services), traces (e.g., diagnostic logging), events, performance metrics, temperature readings, and the like. Observation data 150 further includes data points representing exceptions, for example, errors associated with one or more operations of the operating systems or software applications (e.g., workloads) hosted by the nodes 104. In some examples, the computing environment 102 provides observation data 150 to a telemetry server or directly to the regression detector 110 using, for example, a unified logging service (ULS) or other telemetry aggregation method. In some examples, the telemetry server functions as a data source 108 of observation data 150 for the regression detector 110. In other examples, observation data 150 includes metrics derived from raw telemetry data. For example, data sources 108 of observation data 150 may include nodes 104, VMs, and/or workloads operating on the nodes 104, and/or an aggregator and/or processor that collects and processes observation data 150 from nodes 104, VMs, and/or workloads.

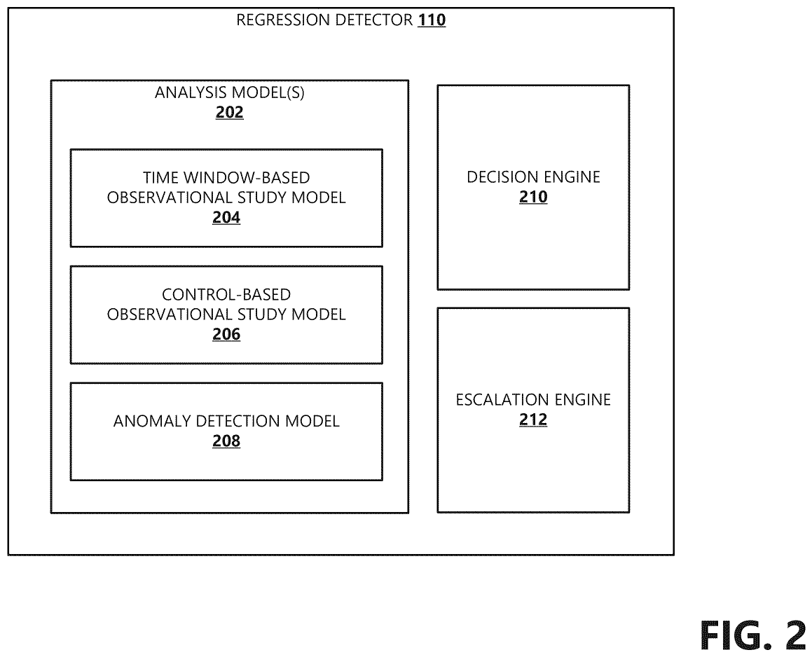

According to an aspect, and with reference now to FIG. 2, the regression detector 110 includes or is in communication with a plurality of analysis models 202 used to evaluate observation data 150 via various analysis techniques to detect regressions 175 attributed to software updates with a high degree of accuracy and precision.

In some examples, the analysis models 202 include a time window-based observational study model 204 configured to perform comparisons of observation data 150 in a first (time window-based) observational study. For instance, the time window-based observational study model 204 may be configured to perform T-tests (e.g., independent or paired T-tests) that compare the means of two time windows, propensity score matching, and/or other statistical testing methods to determine differences between occurrences of failures between different time windows around deployment of a software update. A T-test, as used herein, refers to a statistical analysis that determines whether the difference between the means of two or more groups is statistically significant.

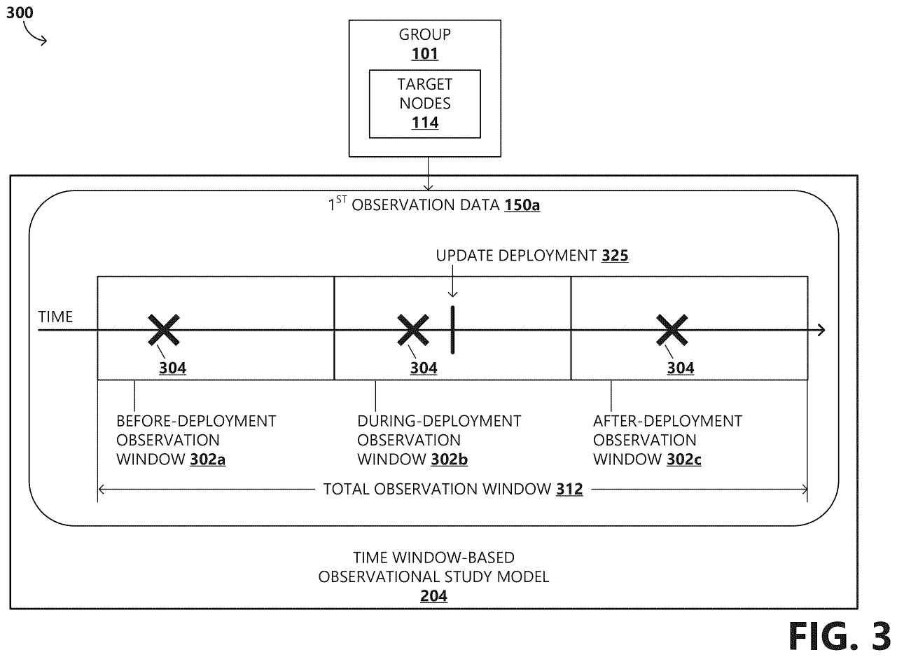

FIG. 3 includes a depiction of a first example observational study 300 performed by the time window-based observational study model 204. In the first observational study 300, various time-based observation windows 302a-302c (collectively, observation windows 302) are defined within a total observation window 312 for normalizing and evaluating first observation data 150a collected from each target node 114 that received the software update. The total observation window 312 refers to a specific period of time around the time of deployment 325 of the software update to a target node 114 during which first observation data 150a of the target node 114 is analyzed. For instance, the total observation window 312 defines start and end points for observing first observation data 150a collected from target nodes 114, VMs, and/or workloads operating on the target nodes 114. As an example, if the total observation window 312 is configured as a two-week duration, the first observation data 150a includes data collected from a start point of one week before the software update was deployed on the target node 114 until an end point of one week after the software update was deployed. The duration of the total observation window 312 may be shorter or longer and, in some examples, is configurable/adjustable.

In examples, the total observation window 312 is segmented in a plurality of time-based observation windows 302 and the first observation data 150a collected from the target nodes 114 is normalized into the time-based observation windows 302. According to one example, the first observation data 150a is normalized into (e.g., assigned to) one of a ‘before-deployment’ observation window 302a (e.g., from 7 days before the deployment 325 to 2 hours before the deployment 325), a ‘during-deployment’ observation window 302b (e.g., from 2 hours before the deployment 325 to 2 hours after the deployment 325), and an ‘after-deployment’ observation window 302c (e.g., from 2 hours after the deployment 325 to 7 days after the deployment 325) for analysis.

In some examples, the time window-based observational study model 204 evaluates the first observation data 150a in each observation window 302 and identifies and records occurrences of failures 304 in each observation window 302. Failures 304 may be identified based on failure criteria, where thresholds are set for different conditions that represent an event where a workload or node 104 on which the workload is executed does not perform as intended or expected (e.g., a crash or failure of a particular software feature to operate, increased latency of a particular software feature, or decreased reliability of a particular software feature). In examples, a failure 304 that is identified as occurring within the during-deployment observation window 302b is recorded as a “during” occurrence, a failure 304 that is identified as occurring within the before-deployment observation window is recorded as a “before” occurrence, and a failure 304 that is identified as occurring within the after-deployment observation window 302c is recorded as an “after” occurrence.

The time window-based observational study model 204 further makes comparisons between ratios of occurrences of failures 304 in the different observation windows 302 (e.g., compare failure rates between the after and before-deployment observation windows 302c and 302a and failure rates between the during and before-deployment observation windows 302b and 302a). In some examples, when the failure rate of the after-deployment observation window 302c is greater than the failure rate of before-deployment observation window 302a (e.g., by at least a threshold amount), the deployment 325 of the software update is flagged as having a first regression condition 120a. In further examples, when the failure rate of the during-deployment observation window 302b is greater than the failure rate of before-deployment observation window 302a (e.g., by at least a threshold amount), the deployment 325 of the software update is flagged as having a second regression condition 120b.

With reference again to FIG. 2, the analysis models 202 utilized by the regression detector 110 further include a control-based observational study model 206 configured to perform comparisons of observation data 150 in a second (control-based) observational study. For instance, the control-based observational study model 206 is configured to perform T-tests, propensity score matching, and/or other statistical testing methods to determine differences between occurrences of failures between control nodes 134 of the group 101 and target nodes 114 in different time windows around deployment 325 of the software update.

In examples, the regression detector 110 selects a control group for comparison against the target nodes 114. For instance, the control group includes a subset of not updated nodes 124 (referred to as control nodes 134) that share one or a combination of control factors in common with the target nodes 114). In some examples, a control node 134 is selected based on a control factor such as having a same or similar hardware and/or software type as the target nodes 114 of the software update (e.g., model and configuration of servers in a data center, model and storage capacity of smartphones in a fleet, model and processor type of computers in an enterprise). For instance, the control nodes 134 represents a pre-update population of the group 101 while the target nodes 114 represent an updated population of the group 101.

The regression detector 110 further obtains second observation data 150b collected from the control nodes 134. The second observation data 150b includes data collected from each control node 134 (e.g., or from VMs and/or workloads operating on the control node 134) during a control observation window 402 defined for evaluation of ambient data in the health analysis. In some examples, the control observation window 402 has a start point that corresponds to the start point of the total observation window 302 of the first target node 114 that the software update was deployed to in a particular phase of the update deployment and an end point that corresponds to the end point of the total observation window 302 of the last target node 114 that the software update was deployed to in the particular phase. In other examples, the control observation window 402 has a similar duration to the total observation window 312 that was defined for evaluation of the first observation data 150a.

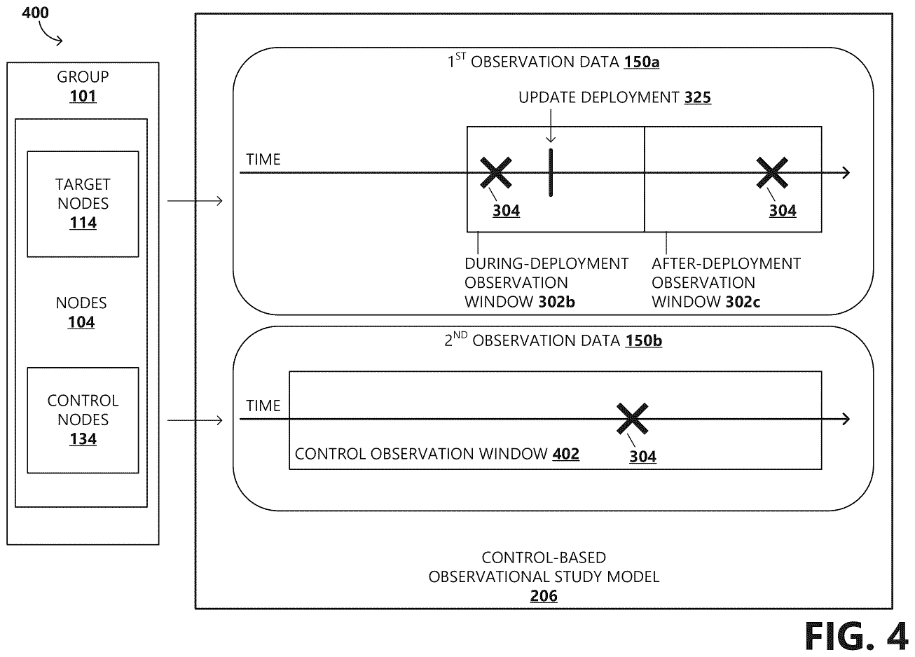

FIG. 4 includes a depiction of a second example observational study 400 performed by the control-based observational study model 206. In the second observational study 400, the control-based observational study model 206 compares failure rates of target nodes 114 of the software update in various observation windows 302 around the update deployment 325 to an ambient failure rate of the control nodes 134. For instance, the control-based observational study model 206. In examples, the control-based observational study model 206 evaluates the second observation data 150b in the control observation window 402 to determine indications of occurrences of failures 304 of control nodes 134 (e.g., failure of the control node 134 or failure of a workload processed by the control node 134). Failures 304 may be identified based on failure criteria, where thresholds are set for different conditions that represent an event where a workload or control node 134 on which the workload is executed does not perform as intended or expected (e.g., a crash or failure of a particular software feature to operate, increased latency of a particular software feature, or decreased reliability of a particular software feature). In examples, a failure 304 that is identified as occurring in the second observation data 150b within the control observation window 402 is recorded as an occurrence of a “control” failure 304. The control-based observational study model 206 further calculates an ambient failure rate of the control group/group 101 (e.g., a ratio of control failures 304 to the number of control nodes 134 in the control group).

In examples, the control-based observational study model 206 further makes comparisons between the calculated ambient failure rate and the failure rates of target nodes 114 in various time-based observation windows 302. In some examples, the time-based observation window failure rates of target nodes 114 are determined by the time-based observational study model 204 and provided to the control-based observational study model 206 for use in the second observational study 400. The control-based observational study model 206 further determines whether results of a comparison between the ambient failure rate and one or more time-based observation window failure rates satisfy a regression condition 120 defined (e.g., configured) for the health analysis. In some examples, when the failure rate of the target nodes 114 in the after-deployment observation window 302c is greater than the ambient failure rate (e.g., by at least a threshold amount), the software update is flagged as having a third regression condition 120c. In further examples, when the failure rate of the target nodes 114 in the during-deployment observation window 302b is greater than the ambient failure rate (e.g., by at least a threshold amount), the software update is flagged as having a fourth regression condition 120d. In other implementations, additional or other regression conditions 120 may be used for comparisons between the first and second observation data 150a and 150b.

With reference again to FIG. 2, the analysis models 202 utilized by the regression detector 110 for performing a health analysis further include an anomaly detection model 208 configured to perform anomaly detection to identify patterns or outliers in observation data 150 that do not conform to expected behavior after the software update is deployed. Example types of anomaly detection models 208 that may be used by the regression detector 110 include an AutoRegressive Integrated Moving Average (ARIMA) model that combines autoregression (AR), differencing (I), and moving average (MA) to predict future points in a series; a Seasonal AutoRegressive Integrated Moving-Average with eXogenous factors (SARIMAX) model that is an extension of the ARIMA model that includes support for seasonality(S) and exogenous variables (X); a Vector AutoRegression (VAR) model that captures linear interdependencies among multiple time series, where each variable in the system is modeled as a linear function of past values of itself and the past values of all the other variables in the system; or another type of model that detects anomalies by forecasting expected values and identifying deviations from the forecasted values.

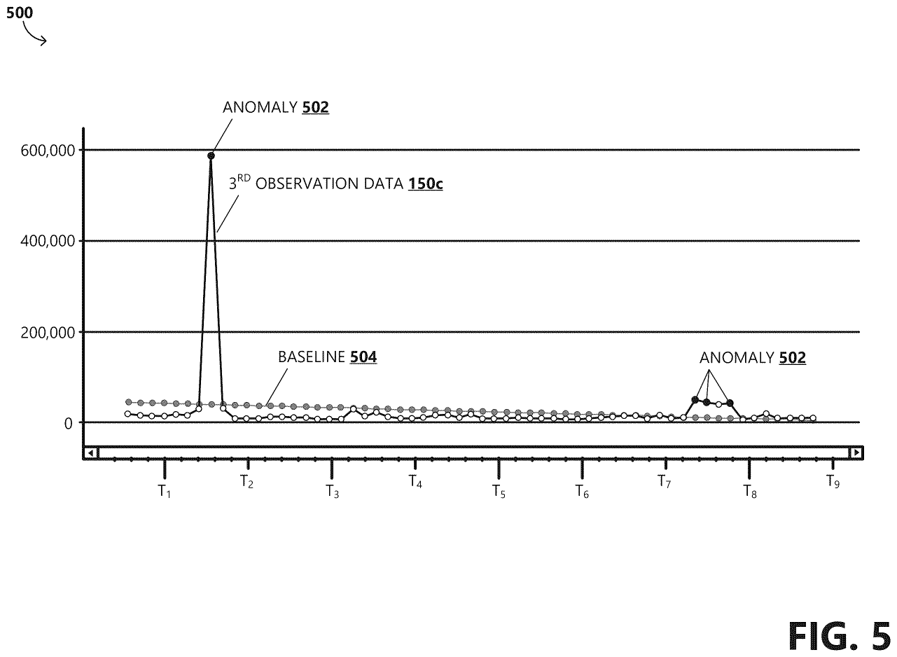

FIG. 5 includes a depiction of an example anomaly detection analysis 500 performed by the anomaly detection model 208 for identifying and recording anomalies 502 of target node health in association with the software update deployment 325. In examples, the anomaly detection model 208 establishes a baseline value 504 of one or a combination of health metrics (e.g., third observation data 150c collected from target nodes 114, VMs, and/or workloads operating on the target nodes 114 that indicate health of the target nodes 114). In some examples, the third observation data 150c includes health data collected within the during and after-deployment observation windows 302b and 302c of the target nodes 114, where the anomaly detection model 208 identifies and flags a value as an anomaly 502 that exceeds the baseline value 504 by at least a threshold amount (e.g., N standard deviations). One example health metric that may be used for anomaly detection is an average number of failures per day for a target node 114. In examples, the anomaly detection model 208 flags the deployment 325 of the software update as having a fifth regression condition 120e when an anomaly 502 is identified.

With reference again to FIG. 2, the regression detector 110 further includes a decision engine 210 configured to receive output of the analysis models 202 and generate a failure signature of the software update based on the received output. For instance, the failure signature may be determined based on one or a combination of flagged regression conditions 120 that indicate whether the failure rate of the after-deployment observation window 302c is greater than the failure rate of before-deployment observation window 302a, the failure rate of the during-deployment observation window 302b is greater than the failure rate of before-deployment observation window 302a, the failure rate of the target nodes 114 in the after-deployment observation window 302c is greater than the ambient failure rate, the failure rate of the target nodes 114 in the during-deployment observation window 302b is greater than the ambient failure rate, and/or whether an anomaly 502 is identified.

In examples, the decision engine 210 compares the failure signature against one or more high confidence regression signatures 130 defined for the health analysis to identify a regression 175 attributed to the software update with high confidence. In some examples, the regression signature(s) 130 and/or combination of regression conditions 120 that define the regression signature(s) 130 is configurable (e.g., based on user (customer) specifications). In some implementations, a user interface is provided via which a user (customer) or a software developer may interact to configure or adjust one or more regression signatures 130 and/or regression conditions 120, which are communicated to the regression detector 110. When a regression 175 is identified, the decision engine 210 flags the software update as having a potential regression attributed to it (e.g., the probability the software update will cause a regression exceeds a threshold amount).

One example set of regression conditions 120 used to identify a regression 175 with high confidence includes a combination of the first regression condition 120a (e.g., the failure rate of the after-deployment observation window 302c is greater than the failure rate of before-deployment observation window 302a), the third regression condition 120c (e.g., the failure rate of the target nodes 114 in the after-deployment observation window 302c is greater than the ambient failure rate), and the fifth regression condition 120e (e.g., an anomaly 502 is identified). Another example set of regression conditions 120 used to identify a regression 175 with high confidence includes a combination of the second regression condition 120b (e.g., the failure rate of the during-deployment observation window 302b is greater than the failure rate of before-deployment observation window 302a), the fourth regression condition 120d (e.g., the failure rate of the target nodes 114 in the during-deployment observation window 302b is greater than the ambient failure rate), and the fifth regression condition 120e (e.g., an anomaly 502 is identified). Other sets of regression conditions 120 may be used to identify a regression 175 with high confidence. By using a combination of data analyses and the set of regression conditions 120, the regression detector 110 accounts for background noise and avoids identifying false positives or low impact problems. For instance, the decision engine 210 is able to identify emerging regression trends with a high degree of accuracy and precision.

In examples, the regression detector 110 further includes an escalation engine 212. When a software update is flagged as having a potential regression 175, the escalation engine 212 generates and transmits an event based on the regression 175. In some examples, the escalation engine 212 generates and transmits an incident log entry of the regression 175 to an intended recipient (e.g., an incident management system). In further examples, the escalation engine 212 generates and transmits a message (e.g., email, text message, or chat message) of the regression 175 to a team member associated with the deployment 325 of the software update. In other examples, transmitting the event includes transmitting a command to halt deployment of the software payload 125 for not updated nodes 124 that have not completed deployment 325 of the software payload 125. In yet other examples, transmitting the event includes transmitting a command to revert deployment of the software payload 125 for target nodes 114 that have completed deployment 325 of the software payload 125.

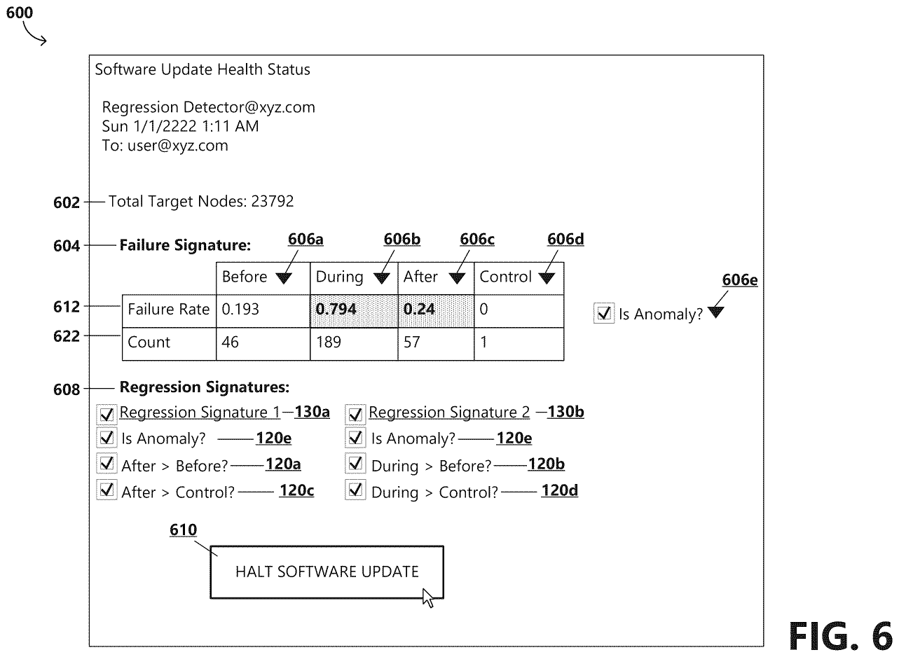

An example message 600 of an identified regression 175 is depicted in FIG. 6, where the message 600 includes information determined based on performing a health analysis for a software update. In some examples, the message 600 includes first information 602 about the number of target nodes 114 included in the health analysis. In further examples, the message 600 includes second information 604 about a failure signature determined for the software update based on results of the analysis models 202. For example, the failure signature includes indications of failures 304 that occurred in various observation windows of the observational studies 300 and 400 and an indication of anomalies 502 detected in the anomaly detection analysis 500. In some examples, the second information 604 includes a count 622 of the identified occurrences of before failures 304, during failures 304, after failures 304, and control failures 304 and determines failures rates 612 for each observation window 302 and the control group. In some examples, one or more options 606a-606e are included in association with one or more elements of the failure signature, which when selected, provide additional information about the selected failure signature element. For instance, selection of an option 606c associated with the after-deployment observation window 302c causes a display of information about the failures 304 identified after the software update was deployed. In some examples, the message 600 further includes third information 608 about one or more regression signatures 130a and 130b defined for the health analysis. For instance, the third information 608 includes indications of satisfied regression conditions 120a-120e included in one or more of the regression signatures 130a and 130b causing the software update to be flagged as a regression 175 with high confidence. In further examples, one or more action options 610 are included in the message 600. For instance, selection of a “halt” action option 610 may cause a command to be transmitted to the software updater 106 to halt deployment of the software payload 125 for not updated nodes 124 that have not completed deployment 325 of the software payload 125. Other types of messages 600 and information included in the messages 600 are contemplated.

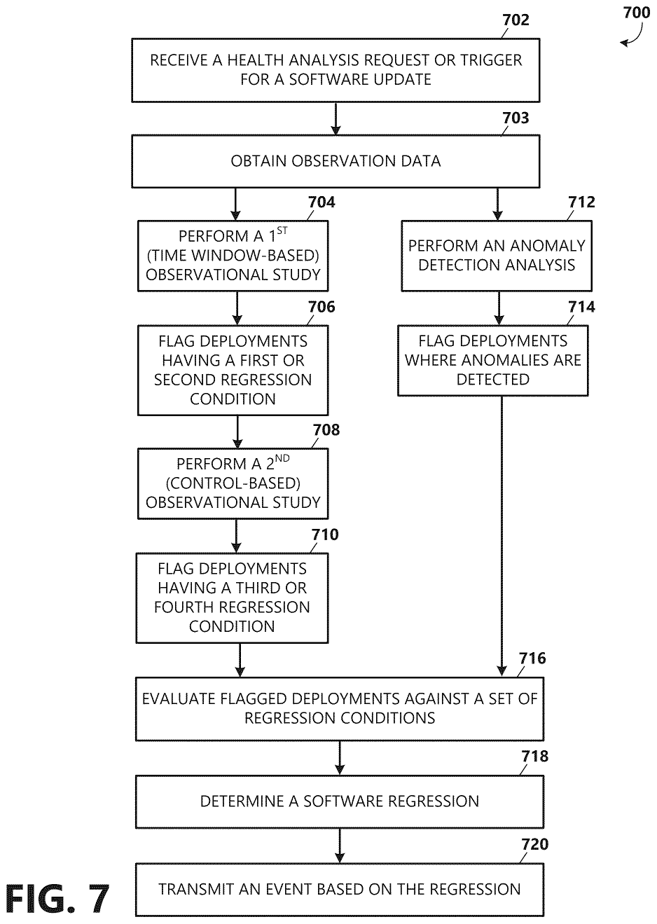

With reference now to FIG. 7, a flow diagram of an example method 700 for detecting a regression 175 related to a software update with high confidence is depicted. At operation 702, a request is received by the regression detector 110 or the regression detector 110 is otherwise triggered to perform a health analysis of the software update. In some examples, the health analysis is triggered or requested after the software update has been deployed in a first phase to a first population of target nodes 114 in a group 101 in a computing environment 102 and prior to the software update being deployed in a second phase to a second population of not updated nodes 124 in the group 101. For instance, the health analysis is requested or triggered to determine whether the software updater 106 should proceed or continue with rolling out a software payload 125 of the software update in an upcoming phase. According to an example, the health analysis is triggered after at least a threshold amount of time has passed since deployment 325 of the software update to a last one of the target nodes 114 in the first population. The threshold amount of time may be based on the duration of the total observation window 312 defined for the health analysis.

At operation 703, the regression detector 110 obtains observation data 150 to evaluate using a plurality of analysis models 202. The observation data 150 may include data collected from nodes 104, VMs, and/or workloads operating on the nodes 104. In examples, the regression detector 110 obtains first observation data 150a associated with the target nodes 114 of the software update. In some examples, the regression detector 110 retrieves or otherwise receives (using a suitable electronic communication protocol or an application programming interface (API)) a plurality of identifiers identifying the target nodes 114 in the group 101 that have completed deployment 325 of the software payload 125 of the software update (e.g., from the software updater 106). In further examples, the software updater 106 provides additional information about the completed deployments 325, such as a time of the deployment 325 to each identified target node 114. Further, the regression detector 110 retrieves or otherwise receives first observation data 150a corresponding to each of the identified target nodes 114 from one or more data sources 108. In examples, the first observation data 150a includes data recorded within the defined total observation window 312 around the time of deployment 325. For instance, if the total observation window 312 is configured as a two week window, the first observation data 150a for each target node 114 may include data recorded from a week prior to the deployment 325 of the software update to the target node 114 until a week after the deployment 325.

In examples, the regression detector 110 additionally obtains second observation data 150b associated with a control group representative of the group 101 for comparison against the first observation data 150a of the target nodes 114. According to an aspect, the regression detector 110 selects control nodes 134 for the control group based on various control factors (e.g., the control group is in the same group 101 as the target nodes 114 and has a similar hardware and/or software configuration to the target nodes 114). In some examples, the control factors are configurable (e.g., additional and/or other control factors may be used to select control nodes 134). According to an example, the regression detector 110 retrieves or otherwise receives (using a suitable electronic communication protocol or an API) a plurality of identifiers identifying the not updated nodes 124 included in the group 101 that have not completed deployment 325 of the software payload 125 of the software update (e.g., from the software updater 106). The regression detector 110 further retrieves or otherwise receives information about other control factors (e.g., configuration of the target nodes 114 and configurations of the not updated nodes 124) and selects not updated nodes 124 that satisfy the other control factors (e.g., are similarly configured to the target nodes 114) as control nodes 134 of the control group. In further examples, the regression detector 110 retrieves or otherwise receives second observation data 150b of each control node 134 recorded within a control observation window 402 (e.g., defined for the health analysis). In some examples, the control observation window 402 corresponds to the total observation window 312 defined for the health analysis.

In some examples, the regression detector 110 additionally obtains third observation data 150c including various indications of health of the target nodes 114 during and after deployment 325 of the software update to the target nodes 114. In other examples, the third observation data 150c is included in the first observation data 150a.

At operation 704, the regression detector 110 performs a first observational study 300 (e.g., a time window-based observational study) of the first observation data 150a. In examples, the time window-based observational study model 204 normalizes the first observation data 150a of the target nodes 114 into various time-based observation windows 302 (e.g., a before-deployment observation window 302a, a during-deployment observation window 302b, and an after-deployment observation window 302c). Further, the time window-based observational study model 204 evaluates the first observation data 150a in each observation window 302 to determine indications of occurrences of failures 304 of target nodes 114 (e.g., failure of the target node 114 or failure of a workload processed by the target node 114). In examples, ratios of occurrences of failures 304 of target nodes 114 during each time-based observation window 302 to the total number of target node deployments 325 (e.g., failure rates) are determined and compared.

In further examples, the time window-based observational study model 204 determines whether results of a comparison between different time-based observation windows 302 satisfy a regression condition 120 defined (e.g., configured) for the health analysis. According to an example implementation, when the failure rate of the after-deployment observation window 302c is greater than the failure rate of before-deployment observation window 302a, at operation 706, the time window-based observational study model 204 flags the software update as having a first regression condition 120a. Additionally at operation 706, the time window-based observational study model 204 flags the software update as having a second regression condition 120b when the failure rate of the during-deployment observation window 302b is greater than the failure rate of before-deployment observation window 302a. In other implementations, additional or other regression conditions 120 may be used to evaluate the observation window-sorted first observation data 150a.

At operation 708, the regression detector 110 performs a second observational study 400 (e.g., a control-based observational study) for comparing the second observation data 150b to the first observation data 150a. In examples, the control-based observational study model 206 evaluates the second observation data 150b in the control observation window 402 to determine indications of occurrences of failures 304 of control nodes 134 (e.g., failure of the control node 134 or failure of a workload processed by the control node 134). The control-based observational study model 206 further calculates an ambient failure rate of the control group/group 101 (e.g., a ratio of occurrences of control node failures 304 to the number of control nodes 134 in the control group).

In some examples, the time-based observation window failure rates of target nodes 114 are determined by the time-based observational study model 204 and provided to the control-based observational study model 206 for use in the second observational study 400. For example, the control-based observational study model 206 makes comparisons between the calculated ambient failure rate and the failure rates of target nodes 114 in various time-based observation windows 302. Further, the control-based observational study model 206 determines whether results of a comparison between the ambient failure rate and one or more time-based observation window failure rates satisfy a regression condition 120 defined (e.g., configured) for the health analysis. According to an example implementation, when the failure rate of the target nodes 114 in the after-deployment observation window 302c is greater than the ambient failure rate, the control-based observational study model 206 flags the software update as having a third regression condition 120c at operation 710. Additionally at operation 710, the control-based observational study model 206 flags the software update as having a fourth regression condition 120d when the failure rate of the target nodes 114 in the during-deployment observation window 302b is greater than the ambient failure rate. In other implementations, additional or other regression conditions 120 may be used for comparisons between the first and second observation data 150a and 150b.

At operation 712, the anomaly detection model 208 performs anomaly detection to identify patterns or outliers in the third observation data 150c that do not conform to expected behavior after the software update is deployed. In some implementations, operation 712 is performed in parallel to operations 704-710. In other implementations, operation 712 is performed before operations 704-710. In yet other implementations, operation 712 is performed after operations 704-710. In examples, the anomaly detection model 208 establishes a baseline value 504 of one or a combination of health metrics corresponding to the third observation data 150c that indicate health of the target nodes 114 (e.g., an average number of failures per day) and flags values as anomalies 502 that exceed the baseline value 504 by at least a threshold amount (e.g., N standard deviations). In examples, at operation 714, the anomaly detection model 208 flags the deployment 325 of the software update as having a fifth regression condition 120e when an anomaly 502 is detected.

At operation 716, the regression detector 110 evaluates output of the analysis models 202 and generates a failure signature of the software update based on the received output. For instance, the failure signature may include a combination of flags indicating one or a combination of regression conditions 120 (e.g., the failure rate of the after-deployment observation window 302c is greater than the failure rate of before-deployment observation window 302a, the failure rate of the during-deployment observation window 302b is greater than the failure rate of before-deployment observation window 302a, the failure rate of the target nodes 114 in the after-deployment observation window 302c is greater than the ambient failure rate, the failure rate of the target nodes 114 in the during-deployment observation window 302b is greater than the ambient failure rate, and/or an anomaly 502 is identified). In examples, the decision engine 210 compares the failure signature against a high confidence regression signature 130 defined for the health analysis to identify a regression 175 with high confidence. When a regression 175 is identified, the decision engine 210 flags the software update as having a potential (e.g., a probability exceeding a threshold amount) regression attributed to it at operation 718.

One example high confidence regression signature 130 used to identify a regression 175 with high confidence includes a combination of the first regression condition 120a (e.g., the failure rate of the after-deployment observation window 302c is greater than the failure rate of before-deployment observation window 302a), the third regression condition 120c (e.g., the failure rate of the target nodes 114 in the after-deployment observation window 302c is greater than the ambient failure rate), and the fifth regression condition 120e (e.g., an anomaly 502 is identified). Another example high confidence regression signature 130 that can be used to identify a regression 175 with high confidence includes a combination of the second regression condition 120b (e.g., the failure rate of the during-deployment observation window 302b is greater than the failure rate of before-deployment observation window 302a), the fourth regression condition 120d (e.g., the failure rate of the target nodes 114 in the during-deployment observation window 302b is greater than the ambient failure rate), and the fifth regression condition 120e (e.g., an anomaly 502 is identified). Other high confidence regression signatures 130 may be used to identify a regression 175 with high confidence.

When the software update is flagged as having a potential regression 175 at operation 718, the regression detector 110 generates and transmits an event based on the regression 175 at operation 720. In some examples, transmitting the event includes generating and transmitting an incident log entry of the regression 175 to an intended recipient (e.g., an incident management system). In further examples, transmitting the event includes generating and transmitting a message (e.g., email, text message, or chat message) of the regression 175 to a team member associated with the deployment 325 of the software update. In other examples, transmitting the event includes transmitting a command to the software updater 106 to halt deployment of the software payload 125 to not updated nodes 124 that have not completed deployment 325 of the software payload 125. In yet other examples, transmitting the event includes transmitting a command to the software updater 106 to revert deployment of the software payload 125 for target nodes 114 that have completed deployment 325 of the software payload 125. By performing operations of method 700, software regression 175 is detected with high confidence and mitigated early in a software payload 125 rollout, resulting in a better user experience and an increase in software security and stability. Some aspects described herein therefore result in more efficient use of computing system resources, and improved operation of computing systems for users.

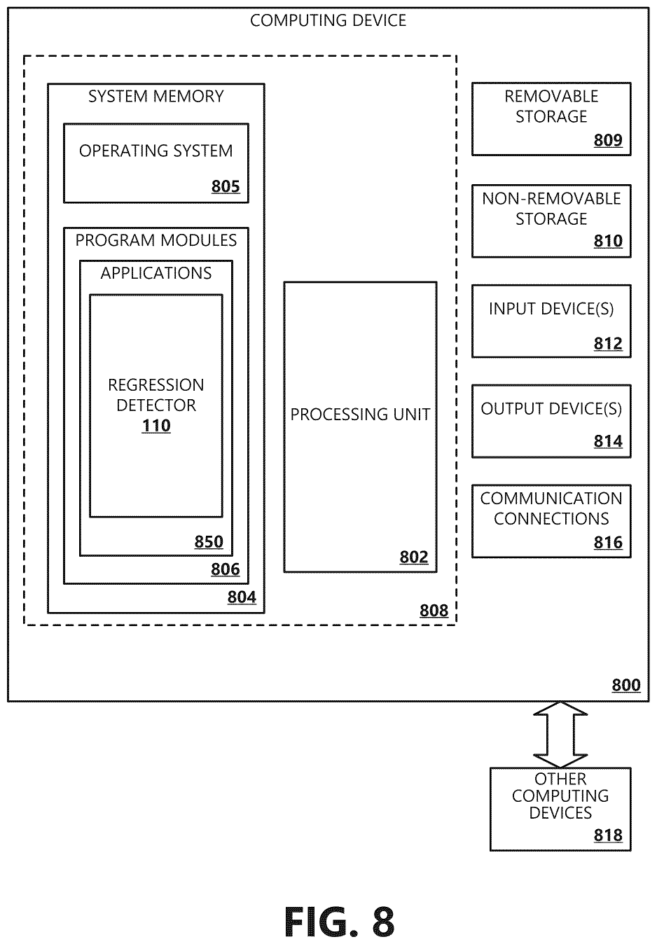

FIG. 8 and the associated description provide a discussion of a variety of operating environments in which examples of the invention may be practiced. However, the devices and systems illustrated and discussed with respect to FIG. 8 is for purposes of example and illustration and is not limiting of a vast number of computing device configurations that may be utilized for practicing aspects of the invention, described herein. FIG. 8 is a block diagram illustrating physical components (i.e., hardware) of a computing device 800 with which examples of the present disclosure may be practiced. In a basic configuration, the computing device 800 may include at least one processing unit and a system memory 804. in examples, the processing unit(s) (e.g., processors) are referred to as a processing system 802. Depending on the configuration and type of computing device, the system memory 804 may comprise volatile storage (e.g., random access memory), non-volatile storage (e.g., read-only memory), flash memory, or any combination of such memories. The system memory 804 may include an operating system 805 and one or more program modules 806 suitable for running software applications 850 (e.g., regression detector 110).

The operating system 805, for example, may be suitable for controlling the operation of the computing device 800. Furthermore, aspects of the invention may be practiced in conjunction with a graphics library, other operating systems, or any other application program and is not limited to any particular application or system. This basic configuration is illustrated in FIG. 8 by those components within a dashed line 808. The computing device 800 may have additional features or functionality. For example, the computing device 800 may also include additional data storage devices (removable and/or non-removable) such as, for example, magnetic disks, optical disks, or tape. Such additional storage is illustrated in FIG. 8 by a removable storage device 809 and a non-removable storage device 810.

As stated above, a number of program modules and data files may be stored in the system memory 804. While executing on the processing system 802, the program modules 806 may perform processes including one or more of the operations of the method 700 illustrated in FIG. 7. Other program modules that may be used in accordance with examples of the present invention and may include applications such as electronic mail and contacts applications, word processing applications, spreadsheet applications, database applications, slide presentation applications, drawing or computer-aided application programs, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to generating suggested queries, may be operated via application-specific logic integrated with other components of the computing device 800 on the single integrated circuit (chip). Examples of the present disclosure may also be practiced using other technologies capable of performing logical operations such as, for example, AND, OR, and NOT, including mechanical, optical, fluidic, and quantum technologies.

The computing device 800 may also have one or more input device(s) 812 such as a keyboard, a mouse, a pen, a sound input device, a touch input device, etc. The output device(s) 814 such as a display, speakers, a printer, etc. may also be included. The aforementioned devices are examples and others may be used. The computing device 800 may include one or more communication connections 816 allowing communications with other computing devices 818. Examples of suitable communication connections 816 include RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 804, the removable storage device 809, and the non-removable storage device 810 are all computer storage media examples (i.e., memory storage.) Computer storage media may include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 800. Any such computer storage media may be part of the computing device 800. Computer storage media does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, communication media may include wired media such as a wired network or direct-wired connection, and wireless media such as acoustic, radio frequency (RF), infrared, and other wireless media.

According to an aspect, a method is provided for performing operations comprising: identifying, from a group of computing nodes, a set of target nodes that have completed a deployment of a software update; obtaining first observation data of the set of target nodes; normalizing the first observation data into a plurality of time-based observation windows around the deployment of the software update; determining a target node failure rate of the set of target nodes in each of the time-based observation windows; detecting a first regression condition associated with the software update by comparing the determined target node failure rates; identifying, from the group of computing nodes, a set of nodes that have not completed deployment of the software update; selecting, from the identified set of nodes that have not completed deployment of the software update, a set of control nodes that have a control factor in common with the set of target nodes; obtaining second observation data of the set of control nodes; determining a control failure rate of the set of control nodes; detecting a second regression condition associated with the software update by comparing the determined control failure rate and one or more of the determined target node failure rates; obtaining third observation data of the set of target nodes; determining a baseline value of a health metric; detecting a third regression condition associated with the software update by comparing the third observation data with the baseline value; detecting a software regression associated with the software update by comparing the first regression condition, the second regression condition, and the third regression condition with a set of high-confidence regression conditions; and in response to detecting the software regression, transmitting an event based on the software regression.

According to an aspect, a computer system is provided comprising: a processing system; and memory storing instructions that, when executed, cause the system to perform operations comprising: identifying, from a group of computing nodes, a set of target nodes that have completed a deployment of a software update; obtaining first observation data of the set of target nodes; normalizing the first observation data into a plurality of time-based observation windows around the deployment of the software update; detecting a first regression condition associated with the software update by performing a first observational study comparing the normalized first observation data; identifying, from the group of computing nodes, a set of nodes that have not completed deployment of the software update; selecting, from the identified set of nodes that have not completed deployment of the software update, a set of control nodes that have a control factor in common with the set of target nodes; obtaining second observation data of the set of control nodes; detecting a second regression condition associated with the software update by performing a first observational study comparing the second observation data to at least a portion of the normalized first observation data; obtaining third observation data of the set of target nodes; detecting a third regression condition associated with the software update by performing an anomaly detection analysis comparing the third observation data with a baseline value; detecting a software regression associated with the software update when the first regression condition, the second regression condition, and the third regression condition match a set of high-confidence regression conditions; and in response to detecting the software regression, transmitting an event based on the software regression.

According to an aspect, a system is provided for performing a health analysis of a software update, comprising: a first observational study model that performs operations comprising: detecting a first regression condition associated with the software update, where the first regression condition is detected by performing a first observational study comparing first observation data collected from a set of target nodes of a group, where the set of target nodes has completed a deployment of the software update; a second observational study model that performs operations comprising: detecting a second regression condition associated with the software update by performing a second observational study comparing at least a portion of the first observation data to second observation data collected from a set of control nodes selected from the group; an anomaly detection model that performs operations comprising: detecting a third regression condition associated with the software update by performing an anomaly detection analysis comparing third observation data collected from the set of target nodes to a baseline value; a decision engine that performs operations comprising: detecting a software regression associated with the software update when the first regression condition, the second regression condition, and the third regression condition match a set of high-confidence regression conditions configured for the health analysis; and an escalation engine that performs operations comprising: in response to detecting the software regression, transmitting an event based on the software regression.

Aspects of the present invention, for example, are described above with reference to block diagrams and/or operational illustrations of methods, systems, and computer program products according to aspects of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. Further, as used herein and in the claims, the phrase “at least one of element A, element B, or element C” is intended to convey any of: element A, element B, element C, elements A and B, elements A and C, elements B and C, and elements A, B, and C.

The description and illustration of one or more examples provided in this application are not intended to limit or restrict the scope of the invention as claimed in any way. The aspects, examples, and details provided in this application are considered sufficient to convey possession and enable others to make and use the best mode of claimed invention. The claimed invention should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope of the claimed invention.

We claim:

1. A method, comprising:
identifying, from a group of computing nodes, a set of target nodes that have completed a deployment of a software update;
obtaining first observation data of the set of target nodes;
normalizing the first observation data into a plurality of time-based observation windows around the deployment of the software update;
determining a target node failure rate of the set of target nodes in each of the time-based observation windows;
detecting a first regression condition associated with the software update by comparing the determined target node failure rates;
identifying, from the group of computing nodes, a set of nodes that have not completed deployment of the software update;
selecting, from the identified set of nodes that have not completed deployment of the software update, a set of control nodes that have a control factor in common with the set of target nodes;
obtaining second observation data of the set of control nodes;
determining a control failure rate of the set of control nodes;
detecting a second regression condition associated with the software update by comparing the determined control failure rate and one or more of the determined target node failure rates;
obtaining third observation data of the set of target nodes;
determining a baseline value of a health metric;
detecting a third regression condition associated with the software update by comparing the third observation data with the baseline value;
detecting a software regression associated with the software update by comparing the first regression condition, the second regression condition, and the third regression condition with a set of high-confidence regression conditions; and
in response to detecting the software regression, transmitting an event based on the software regression.

2. The method of claim 1, wherein normalizing the first observation data into the plurality of time-based observation windows comprises normalizing, for each target node in the set of target nodes, the first observation data into:
a first observation window corresponding to a before-deployment time window before the deployment of the software update to the target node;
a second observation window corresponding to a during-deployment time window including the deployment of the software update to the target node; and
a third observation window corresponding to an after-deployment time window after the deployment of the software update to the target node.

3. The method of claim 1, wherein determining the target node failure rate of the set of target nodes in each of the time-based observation windows comprises:
determining a before-deployment failure rate;
determining a during-deployment failure rate; and
determining an after-deployment failure rate.

4. The method of claim 3, wherein detecting the first regression condition comprises:
determining a difference between the before-deployment failure rate and the after-deployment failure rate; and
when the difference exceeds a threshold, determining the first regression condition is detected.

5. The method of claim 3, wherein detecting the first regression condition comprises:
determining a difference between the before-deployment failure rate and the during-deployment failure rate; and
when the difference exceeds a threshold, determining the first regression condition is detected.

6. The method of claim 3, wherein detecting the second regression condition comprises:
determining a difference between the control failure rate and the after-deployment failure rate; and
when the difference exceeds a threshold, determining the second regression condition is detected.

7. The method of claim 3, wherein detecting the second regression condition comprises:
determining a difference between the control failure rate and the during-deployment failure rate; and
when the difference exceeds a threshold, determining the second regression condition is detected.

8. The method of claim 7, wherein:
the set of high-confidence regression conditions include:
an anomaly;
the difference between the before-deployment failure rate and the after-deployment failure rate exceeding a threshold; and
the difference between the control failure rate and the after-deployment failure rate exceeding a threshold; and
detecting the software regression comprises determining the first regression condition, the second regression condition, and the third regression condition match the set of high-confidence regression conditions.

9. The method of claim 7, wherein:
the set of high-confidence regression conditions include:
an anomaly;
the difference between the before-deployment failure rate and the during-deployment failure rate exceeding a threshold; and
the difference between the control failure rate and the during-deployment failure rate exceeding a threshold; and
detecting the software regression comprises determining the first regression condition, the second regression condition, and the third regression condition match the set of high-confidence regression conditions.

10. The method of claim 1, wherein detecting the third regression condition comprises detecting an anomaly using anomaly detection analysis.

11. The method of claim 1, wherein transmitting the event based on the software regression comprises transmitting at least one selected from a group including:
a message;
an incident management system log entry;
a command to halt deployment of the software update to the set of nodes that have not completed deployment of the software update; and
a command to revert deployment of the software update to the set of nodes that have not completed deployment of the software update.

12. A system, comprising:
a processing system; and
memory storing instructions that, when executed, cause the system to perform operations comprising:
identifying, from a group of computing nodes, a set of target nodes that have completed a deployment of a software update;
obtaining first observation data of the set of target nodes;
normalizing the first observation data into a plurality of time-based observation windows around the deployment of the software update;
detecting a first regression condition associated with the software update by performing a first observational study comparing the normalized first observation data;
identifying, from the group of computing nodes, a set of nodes that have not completed deployment of the software update;
selecting, from the identified set of nodes that have not completed deployment of the software update, a set of control nodes that have a control factor in common with the set of target nodes;
obtaining second observation data of the set of control nodes;
detecting a second regression condition associated with the software update by performing a first observational study comparing the second observation data to at least a portion of the normalized first observation data;
obtaining third observation data of the set of target nodes;
detecting a third regression condition associated with the software update by performing an anomaly detection analysis comparing the third observation data with a baseline value;
detecting a software regression associated with the software update when the first regression condition, the second regression condition, and the third regression condition match a set of high-confidence regression conditions; and
in response to detecting the software regression, transmitting an event based on the software regression.

13. The system of claim 12, wherein:
the plurality of time-based observation windows comprises:
a first observation window corresponding to a before-deployment time window before the deployment of the software update;
a second observation window corresponding to a during-deployment time window including the deployment of the software update; and
a third observation window corresponding to an after-deployment time window after the deployment of the software update; and
the first observational study comprises:
determining a before-deployment failure rate by analyzing the first observation data normalized into the before-deployment time window;
determining a during-deployment failure rate by analyzing the first observation data normalized into the during-deployment time window; and
determining an after-deployment failure rate by analyzing the first observation data normalized into the after-deployment time window.

14. The system of claim 13, wherein the first observational study further comprises:
determining a first difference between the before-deployment failure rate and the after-deployment failure rate;
determining a second difference between the before-deployment failure rate and the during-deployment failure rate; and
when the first or second difference exceeds a threshold, determining the first regression condition is detected.

15. The system of claim 13, wherein the second observational study comprises:
determining a control failure rate of the set of control nodes;
determining a first difference between the control failure rate and the after-deployment failure rate;
determining a second difference between the control failure rate and the during-deployment failure rate; and
when the first or second difference exceeds a threshold, determining the second regression condition is detected.

16. The system of claim 12, wherein the third observational study comprises:
determining a difference between when the third observation data and the baseline value; and
when the difference exceeds a threshold, determining the third regression condition is detected.

17. The system of claim 12, wherein the event comprises at least one selected from a group including:
a message;
an incident management system log entry;
a command to halt deployment of the software update to the set of nodes that have not completed deployment of the software update; and
a command to revert deployment of the software update to the set of nodes that have not completed deployment of the software update.

18. The system of claim 12, wherein the set of high-confidence regression conditions is configurable.

19. A system for performing a health analysis of a software update, comprising:
a first observational study model that performs operations comprising:
detecting a first regression condition associated with the software update, where the first regression condition is detected by performing a first observational study comparing first observation data collected from a set of target nodes of a group, where the set of target nodes has completed a deployment of the software update;
a second observational study model that performs operations comprising:
detecting a second regression condition associated with the software update by performing a second observational study comparing at least a portion of the first observation data to second observation data collected from a set of control nodes selected from the group;
an anomaly detection model that performs operations comprising:
detecting a third regression condition associated with the software update by performing an anomaly detection analysis comparing third observation data collected from the set of target nodes to a baseline value;
a decision engine that performs operations comprising:
detecting a software regression associated with the software update when the first regression condition, the second regression condition, and the third regression condition match a set of high-confidence regression conditions configured for the health analysis; and
an escalation engine that performs operations comprising:
in response to detecting the software regression, transmitting an event based on the software regression.

20. The system of claim 19, wherein the event comprises at least one selected from a group
including:
a message;
an incident management system log entry;
a command to halt deployment of the software update to nodes in the group that have not completed deployment of the software update; and
a command to revert deployment of the software update to the nodes in the group that have not completed deployment of the software update.
